(19) United States
(12) Patent Application Publication
(10) Pub. No.: US 2026/0099102 A1
(43) Pub. Date: Apr. 9, 2026

(54) ELECTROPHOTOGRAPHIC PHOTORECEPTOR, AND PROCESS CARTRIDGE AND IMAGE FORMING APPARATUS INCLUDING THE SAME

(71) Applicant: SHARP KABUSHIKI KAISHA, Osaka (JP)

(72) Inventors: Takahiro KURAUCHI, Osaka (JP); Akiko KIHARA, Osaka (JP)

(21) Appl. No.: 19/345,017

(22) Filed: Sep. 30, 2025

(30) Foreign Application Priority Data
Oct. 3, 2024 (JP) 2024-174500

(51) Int. Cl. G03G 5/047; G03G 5/05; G03G 5/14; G03G 15/02; G03G 21/00; G03G 21/18

(52) U.S. Cl. CPC G03G 5/047; G03G 5/0507; G03G 5/0517; G03G 5/142; G03G 15/0216; G03G 21/0011; G03G 21/1814; G03G 2221/0005

(57) ABSTRACT

An electrophotographic photoreceptor includes, on a conductive support, a laminated photosensitive layer in which a charge generating layer containing a charge generating material and a charge transporting layer containing a hole transporting material are laminated in this order, or the laminated photosensitive layer and a surface protecting layer laminated on the laminated photosensitive layer, wherein an outermost surface layer of the electrophotographic photoreceptor contains an electron transporting material having a maximum absorption at a wavelength of equal to or less than 500 nm in a spectral absorption spectrum and a silica particle, a mass ratio of the silica particle to the electron transporting material is 1.0 to 5.0, and an impedance change rate of the electrophotographic photoreceptor when a frequency is changed from 4 Hz to 50 Hz is −96% to −91%.

### FIELD OF THE INVENTION

The disclosure relates to an electrophotographic photoreceptor (hereinafter, also referred to as a “photoreceptor”), and a process cartridge and an image forming apparatus including the electrophotographic photoreceptor.

### BACKGROUND ART

An image forming apparatus according to an electrophotographic method in which an image is formed by using an electrophotographic technique is widely used in a copying machine, a printer, a facsimile machine, and the like.

Then, as a charging device of the image forming apparatus, a corotron charger in which wire and a case are used, and a scorotron charger in which wire, a case, and additionally a grid electrode (hereinafter, also referred to as a “grid”) are used are frequently used. In particular, the scorotron charger has an advantage that a surface potential of the photoreceptor can be stably controlled by the grid disposed between the wire and a surface of the photoreceptor, and is widely used as a charger.

However, these chargers need to be applied with a high voltage of 5 to 8 kV, and have a disadvantage of generating a large amount of ozone.

Thus, in order to solve such a disadvantage, as a charger in which a constituent member of a charging device is brought into contact with or close to a photoreceptor, for example, a contact roller charger, a non-contact roller charger, a brush charger, a magnetic brush charger, and the like have been developed.

In these chargers, except for some chargers according to an injection charging method, a charging method by micro-gap discharge is utilized, and these chargers are now becoming mainstream chargers as chargers with which power consumption can be reduced as compared with the scorotron chargers in the related art and the problems of high voltage power supply and ozone generation that were the drawbacks can be solved. Among these, the contact roller charger (herein after, also referred to as a “charging roller”) is excellent in charging stability and is most widely used.

### Technical Problem

However, in a case where a contact roller charger is in contact with a photoreceptor for a long period of time, even when a charging roller is not applied with a voltage and the photoreceptor does not rotate, the charging roller is deformed by a pressure between the charging roller and the photoreceptor, so that charge is generated, and a piezoelectric effect occurs in which a current flows between the charging roller and the photoreceptor. As a result, black streak-like defects (also referred to as “piezoelectric streaks”) may occur on a halftone image at a contact portion.

Therefore, a method of mechanically separating a charging roller and a photoreceptor has been proposed. However, there is a problem that the apparatus becomes complicated.

Further, a method of suppressing image defects by applying a surface potential of equal to or greater than −600 V and equal to or less than −300 V to a surface of a photoreceptor at the end of driving of the photoreceptor has been proposed.

However, the above does not serve as a fundamental solution, and there is a problem that a load is applied to the photoreceptor by applying the surface potential every time the photoreceptor is stopped, and a life of the photoreceptor is shortened. On the other hand, in order to achieve a long life of a photoreceptor, a method of incorporating inorganic particles such as silica into an outermost surface layer of the photoreceptor has been proposed. However, it is known that the above piezoelectric streaks are likely to occur when the silica particles are contained in the outermost surface layer, and there is a problem that recoverability of the photoreceptor is low.

### SUMMARY

Accordingly, an object of the disclosure is to provide a long-life photoreceptor with which streak-like image defects (piezoelectric streaks) caused by contact between the photoreceptor and a charger can be suppressed and good image quality can be continuously obtained for a long period of time, and a process cartridge and an image forming apparatus including the photoreceptor.

As a result of intensive studies to solve the above problems, the inventors have found that a photoreceptor containing an electron transporting material having a specific absorption wavelength and silica particles in a charge transporting layer and exhibiting a specific impedance change rate suppresses streak-like image defects (piezoelectric streaks) caused by contact between the photoreceptor and a charger, so that a long-life photoreceptor with which good image quality can be continuously obtained for a long period of time, and further a process cartridge and an image forming apparatus including the photoreceptor can be provided, thereby completing the disclosure.

Thus, according to the disclosure, there is provided an electrophotographic photoreceptor at least including, on a conductive support, a laminated photosensitive layer in which a charge generating layer containing a charge generating material and a charge transporting layer containing a hole transporting material are laminated in this order, or the laminated photosensitive layer and a surface protecting layer laminated on the laminated photosensitive layer, wherein the charge transporting layer or the surface protecting layer serving as an outermost surface layer of the electrophotographic photoreceptor contains an electron transporting material having a maximum absorption at a wavelength of equal to or less than 500 nm in a spectral absorption spectrum and a silica particle, and a mass ratio of the silica particle to the electron transporting material is 1.0 to 5.0, and an impedance change rate of the electrophotographic photoreceptor when a frequency is changed from 4 Hz to 50 Hz is −96% to −91%.

Additionally, according to the disclosure, there is provided a process cartridge including the above electrophotographic photoreceptor, and at least one selected from a charging device that is a contact roller charger that charges the electrophotographic photoreceptor, a developing device that develops an electrostatic latent image formed by exposure to form a toner image, and a cleaning device that removes toner remaining on the electrophotographic photoreceptor.

Further, according to the disclosure, there is provided an image forming apparatus including at least the above electrophotographic photoreceptor, a charging device that is a contact roller charger that charges the electrophotographic photoreceptor, an exposing device that exposes the charged electrophotographic photoreceptor to form an electrostatic latent image, a developing device that develops the electrostatic latent image to form a toner image, and a transferring device that transfers the toner image onto a recording medium.

According to the disclosure, it is possible to provide a long-life photoreceptor with which streak-like image defects (piezoelectric streaks) caused by contact between the photoreceptor and a charger can be suppressed and good image quality can be continuously obtained for a long period of time, and a process cartridge and an image forming apparatus including the photoreceptor.

### BRIEF DESCRIPTION OF THE DRAWINGS

FIG. 1 is a schematic cross-sectional view illustrating a configuration of a main part of a photoreceptor F01 of the disclosure.

FIG. 2 is a schematic side view illustrating a configuration of a main part of an image forming apparatus 50 of the disclosure.

FIG. 3 is a graph showing spectral absorption spectra of electron transporting materials (compounds 1 and 2) used in Examples and an electron transporting material (compound 3) used in Comparative Example.

FIG. 4 is a chemical structural formula of the compound 1 being the electron transporting material.

FIG. 5 is a chemical structural formula of the compound 2 being the electron transporting material.

FIG. 6 is a chemical structural formula of Y-type oxotitanyl phthalocyanine of a charge generating material.

FIG. 7 is a chemical structural formula of a stilbene derivative (compound 4) of a hole transporting material.

FIG. 8 is a chemical structural formula of the compound 3 being the electron transporting material.

FIG. 9 is a table showing main constituent materials of photoreceptors and physical properties thereof, physical properties of the photoreceptors and each part thereof, and physical properties of charging rollers.

FIG. 10 is a table showing evaluation results of the photoreceptors and the charging rollers.

### DESCRIPTION OF EMBODIMENTS

A photoreceptor of the disclosure is an electrophotographic photoreceptor at least including, on a conductive support, a laminated photosensitive layer in which a charge generating layer containing a charge generating material and a charge transporting layer containing a hole transporting material are laminated in this order, or the laminated photosensitive layer and a surface protecting layer laminated on the laminated photosensitive layer, wherein the charge transporting layer or the surface protecting layer serving as an outermost surface layer of the electrophotographic photoreceptor contains an electron transporting material having a maximum absorption at a wavelength of equal to or less than 500 nm in a spectral absorption spectrum and a silica particle, and a mass ratio of the silica particle to the electron transporting material is 1.0 to 5.0, and an impedance change rate of the electrophotographic photoreceptor when a frequency is changed from 4 Hz to 50 Hz is −96% to −91%.

Hereinafter, main constituent requirements that are features of the photoreceptor of the disclosure will be described, and then (1) the photoreceptor, (2) a process cartridge and (3) an image forming apparatus including the photoreceptor will be described.

Note that embodiments and Examples described below are merely specific examples of the disclosure, and the disclosure is not limited thereto.

The charge transporting layer or the surface protecting layer serving as the outermost surface layer of the photoreceptor of the disclosure contains the electron transporting material having the maximum absorption at the wavelength of equal to or less than 500 nm in the spectral absorption spectrum and the silica particles.

When the outermost surface layer of the photoreceptor contains the silica particles, a surface of the silica particles tends to be negatively charged and has an action of holding a positive charge generated by a piezoelectric effect, and thus it is considered that piezoelectric streaks are more significant and recoverability is reduced. In the photoreceptor of the disclosure, the electron transporting material is considered to relax the negative charge on the surface of the silica particles.

In addition, it is considered that, since the electron transporting material has the maximum absorption at the wavelength of equal to or less than 500 nm, a HOMO-LUMO gap is larger as compared with a compound having a maximum absorption at equal to or greater than 500 nm, and is less likely to be affected by positive charge, and thus, the negative charging of the surface of the silica particles can be more efficiently relaxed.

In general, a light source used in an exposing device or a charge neutralizing device according to an electrophotographic method has a wavelength of 600 to 800 nm in many cases. The electron transporting material used in the photoreceptor of the disclosure has the maximum absorption equal to or less than 500 nm, and therefore, there is an advantage that the electron transporting material does not absorb light from the above light source, and does not adversely affect electrical characteristics such as sensitivity of the photoreceptor even when added in a large amount.

When the maximum absorption wavelength of the electron transporting material exceeds 500 nm, the electron transporting material may absorb light from the light source used in the exposing device or the charge neutralizing device as described above, which may cause adverse effects. The maximum absorption wavelength of the electron transporting material is preferably 350 to 450 nm.

A method for measuring the spectral absorption spectrum will be described in detail in Examples.

### Electron Transporting Material

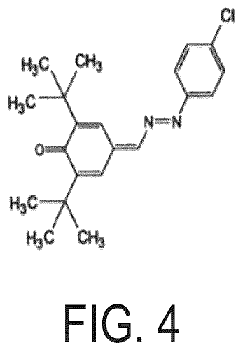

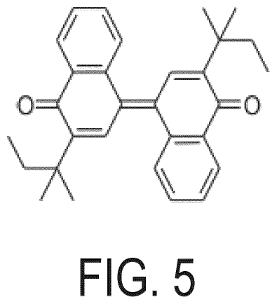

The electron transporting material is not particularly limited as long as the electron transporting material is an electron transporting compound having an action of relaxing the negative charge on the surface of the silica particles and satisfying the above requirement of the maximum absorption in the spectral absorption spectrum. Examples of the electron transporting material include a compound (compound 1) represented by a structural formula in FIG. 4:
and a compound (compound 2) represented by a structural formula in FIG. 5;
and the compound 1 is particularly preferred from a viewpoint of a shorter maximum absorption wavelength.

As the electron transporting material, additionally, one or more electron transporting materials (acceptor-type compounds) such as succinic anhydride, maleic anhydride, dibromosuccinic anhydride, phthalic anhydride, 3-nitrophthalic anhydride, 4-nitrophthalic anhydride, pyromellitic anhydride, pyromellitic acid, trimellitic acid, trimellitic anhydride, phthalimide, 4-nitrophthalimide, tetracyanoethylene, tetracyanoquinodimethane, chloranil, bromanil, o-nitrobenzoic acid, malononitrile, trinitrofluorenone, trinitrothioxanthone, dinitrobenzene, dinitroanthracene, dinitroacridine, nitroanthraquinone, dinitroanthraquinone, a thiopyran-based compound, a quinone-based compound, a benzoquinone-based compound, a diphenoquinone-based compound, a naphthoquinone-based compound, an azoquinone-based compound, an anthraquinone-based compound, a diiminoquinone-based compound, and a stilbenequinone-based compound can be used alone or in an appropriate combination of two or more as long as the effects of the photoreceptor of the disclosure are not impaired.

### Silica Particles

“Silica” of silica particles means silicon dioxide (SiO₂).

Examples of the silica particles preferably used in the disclosure include fumed silica obtained by burning silicon tetrachloride, regardless of manufacturing method, dry-process silica such as arc-process silica obtained by atomizing silica in a gas phase by high energy such as plasma, precipitated silica synthesized under an alkaline condition using a sodium silicate aqueous solution as a raw material, wet-process silica such as gel-process silica synthesized under an acidic condition, and sol-gel process silica obtained by hydrolyzing an organosilane compound.

The surface of the silica particles may be treated with a surface treatment agent in order to improve the electrical characteristics of the photoreceptor.

Examples of the surface treatment agent include hexamethyldisilazane, N-methyl-hexamethyldisilazane, N-ethyl-hexamethyldisilazane, hexamethyl-N-propyldisilazane, dimethyldichlorosilane, and polydimethylsiloxane.

Among these, dimethyldichlorosilane and hexamethyldisilazane are particularly preferable because they have good reactivity with a hydroxyl group on a surface of silica fine particles, and therefore, the hydroxyl group on the surface of the silica particles can be reduced, and as a result, a deterioration of the electrical characteristics of the photoreceptor due to moisture (humidity) can be suppressed.

In the disclosure, the silica particles treated with the above surface treatment agent can be used, and commercially available fine particles can also be used. Examples of commercially available fine particles include products of NIPPON AEROSIL CO., LTD.: R972, R972V, R974, R976, RX200, NX130, NX90G, NX90S, NAX50, RX50 and products of Cabot Japan K.K.: TS610, TG709F, TG6110G, and a product of Admatechs Co., Ltd.: YA010C.

### Content of Silica Particles

In order to extend the life of the photoreceptor, it is necessary to improve printing durability, and therefore, it is more effective to add a large amount of silica particles. However, when a large amount of silica particles is added, piezoelectric streaks are deteriorated, and therefore, it is necessary to add a larger amount of electron transporting materials.

In the photoreceptor of the disclosure, the mass ratio of silica particles to the electron transporting material is 1.0 to 5.0. The present inventors have found that as far as the mass ratio of the silica particles is in the above range, the printing durability can be improved and the piezoelectric streaks can be suppressed.

When the mass ratio of the silica particles is less than 1.0, sufficient printing durability is not obtained in some cases. On the other hand, when the mass ratio of the silica particles exceeds 5.0, an effect of improving the piezoelectric streaks is not sufficiently obtained in some cases.

The mass ratio of silica particles is preferably 2.0 to 4.0, and more preferably 3.0 to 4.0.

### BET Specific Surface Area of Silica Particles

In the photoreceptor of the disclosure, the silica particles preferably have a BET specific surface area of 100 to 200 m²/g as defined in JIS Z8830: 2013.

When the BET specific surface area is less than 100 m²/g, the printing durability may be deteriorated. On the other hand, when the BET specific surface area exceeds 200 m²/g, the effect of improving the piezoelectric streaks is not sufficiently obtained in some cases.

The BET specific surface area of the silica particles is more preferably 110 to 170 m²/g and still more preferably 120 to 150 m²/g.

A method for measuring the BET specific surface area will be described in detail in Examples.

### Impedance Change Rate of Photoreceptor

In the photoreceptor of the disclosure, the impedance change rate when the frequency is changed from 4 Hz to 50 Hz is −96% to −91%.

Impedance of a photoreceptor is determined by not only an outermost surface layer thereof but also all layers constituting the photoreceptor such as an undercoat layer and a charge generating layer described below. In general, the impedance of the photoreceptor tends to decrease as the frequency increases.

The present inventors have found that there is a correlation between recoverability of the piezoelectric streaks and the impedance change rate of the photoreceptor when the frequency is changed from 4 Hz to 50 Hz, and the recoverability of the piezoelectric streaks is good in the photoreceptor having the impedance change rate of −96% to −91%.

Although the mechanism is not clear, it is considered that charge movement and charge retention between the photoreceptor and a charging roller occur at a constant cycle and the reason why the charge retention is eliminated, that is, recoverability of the piezoelectric streaks is good is that charge movement inside the photoreceptor is faster than the charge movement and the charge retention between the photoreceptor and the charging roller. Then, this corresponds to an impedance change rate when a voltage of a low frequency (50 Hz) is applied to the photoreceptor, and it is presumed that charge movement inside a photoreceptor having a higher impedance change rate is faster, and charge retention can be eliminated.

When the impedance change rate is less than −96%, the effect of improving the piezoelectric streaks is not sufficiently obtained in some cases. On the other hand, when the impedance change rate exceeds −91%, the electrical characteristics (charging stability) of the photoreceptor may be deteriorated.

The impedance change rate of the photoreceptor is more preferably −95% to −92%, and still more preferably −94% to −93%.

A method for measuring the impedance will be described in detail in Examples.

### (1) Electrophotographic Photoreceptor

The photoreceptor of the disclosure at least includes, on the conductive support, the laminated photosensitive layer in which the charge generating layer containing the charge generating material and the charge transporting layer containing the hole transporting material are laminated in this order, or the laminated photosensitive layer and the surface protecting layer laminated thereon.

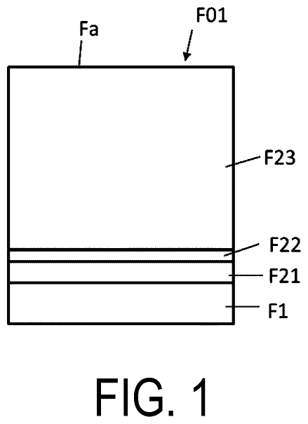

FIG. 1 is a schematic cross-sectional view illustrating a configuration of a main part of the photoreceptor F01 of the disclosure.

The photoreceptor F01 includes, on a conductive support F1, an undercoat layer F21, and a photosensitive layer (laminated photosensitive layer) in which a charge generating layer F22 containing a charge generating material and a charge transporting layer F23 containing a charge transporting material are laminated in this order. Note that a reference symbol Fa denotes a surface of the photoreceptor. The photoreceptor of the disclosure may include the undercoat layer F21 between the conductive support F1 and the laminated photosensitive layer as described below.

### Conductive Support F1

The conductive support (also referred to as a “conductive substrate” or a “substrate”) has a function as an electrode of the photoreceptor and a function as a support member, and a constituent material thereof is not particularly limited as long as the material used in the art.

Specifically, examples of the conductive support include metal materials such as aluminum, aluminum alloys, copper, zinc, stainless steel, and titanium; and polymer materials such as polyethylene terephthalate, nylon, and polystyrene, hard paper, and glass, surfaces of which are subjected to metal foil lamination, metal vapor deposition treatment, or vapor deposition or coating of a layer of conductive compounds such as conductive polymers, tin oxide, indium oxide and the like. Among these, aluminum is preferable in terms of ease of processing, and aluminum alloys such as JIS 3003 series, JIS 5000 series, and JIS 6000 series alloys are particularly preferable.

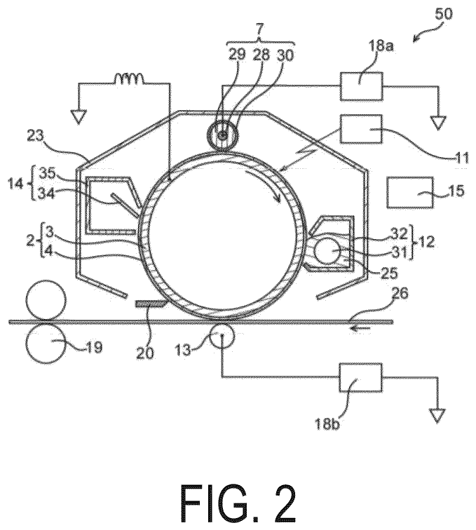

A shape of the conductive support is not limited to a cylindrical shape (drum shape) as illustrated in FIG. 2, and may be a sheet shape, a columnar shape, an endless belt shape, or the like.

Further, a surface of the conductive support may be subjected to an anodic oxidation coating treatment, a surface treatment with chemicals or hot water, a coloring treatment, or a diffuse reflection treatment such as surface roughening, as necessary, in order to prevent interference fringes due to laser light, within a range not affecting the image quality.

### Undercoat Layer F21

The photoreceptor F01 of the disclosure preferably includes the undercoat layer (also referred to as an “intermediate layer”) F21 between the conductive support F1 and the laminated photosensitive layer (also simply referred to as the “photosensitive layer”).

The undercoat layer generally covers and uniformizes unevenness of the surface of the conductive support, enhances film formability of the photosensitive layer with the charge generating layer, suppresses peeling of the photosensitive layer from the conductive support, and improves adhesiveness between the conductive support and the photosensitive layer. Specifically, charge injection from the conductive support to the photosensitive layer can be prevented, a deterioration in chargeability of the photosensitive layer can be prevented, fogging (so-called black spots) of an image can be prevented, and good electrophotographic characteristics such as chargeability can be maintained throughout the life.

The undercoat layer can be formed by, for example, dissolving a binder resin in an appropriate solvent to prepare a coating liquid for an undercoat layer, applying the coating liquid to the surface of the conductive support, and removing an organic solvent by drying.

Examples of the binder resin include natural polymer materials such as casein, gelatin, polyvinyl alcohol, and ethyl cellulose, in addition to a binder resin similar to that contained in the photosensitive layer described below, and these can be used alone or in combination of two or more.

The binder resin is required to have characteristics so as to cause no dissolution or swelling in a solvent used for forming the photosensitive layer on the undercoat layer, to be excellent in adhesiveness to the conductive support, and to be flexibility, thus among the above binder resins, a polyamide resin is preferable, and an alcohol-soluble nylon resin is particularly preferable.

Examples of the alcohol-soluble nylon resin include homopolymerized or copolymerized nylons such as 6-nylon, 66-nylon, 610-nylon, 11-nylon, and 12-nylon, and types of resin obtained by chemically modifying nylon such as N-alkoxymethyl modified nylon.

Examples of a solvent for dissolving or dispersing a resin material include water; alcohols such as methanol, ethanol, and butanol; glymes such as methyl carbitol and butyl carbitol; chlorine-based solvents such as dichloroethane, chloroform, and trichloroethane; acetone, dioxolane, and mixed solvents obtained by mixing two or more of these solvents. Among these solvents, non-halogen-based organic solvents are preferably used in consideration of the global environment.

Further, the coating liquid for the undercoat layer may contain inorganic compound fine particles. The inorganic compound fine particles in the undercoat layer are different in blending purpose from the silica particles in the outermost surface layer, and may be the same compound or different compounds.

The inorganic compound fine particles can easily adjust a volume resistance value of the undercoat layer, can further suppress injection of charge into the laminated photosensitive layer, and can maintain the electrical characteristics of the photoreceptor under various environments.

Examples of the inorganic compound fine particles include fine particles of titanium oxide, aluminum oxide, aluminum hydroxide, tin oxide, and the like.

In order to disperse the inorganic compound fine particles in the coating liquid for the undercoat layer, a known apparatus such as a ball mill, a sand mill, an attritor, a vibration mill, an ultrasonic disperser, or a paint shaker may be used.

A ratio A/B of a total mass A of the binder resin and the inorganic compound fine particles to a mass B of the solvent in the coating liquid for the undercoat layer is preferably 1/99 to 40/60, and particularly preferably 2/98 to 30/70.

Additionally, a ratio C/D of a mass C of the binder resin to a mass D of the inorganic compound fine particles is preferably 1/99 to 90/10, particularly preferably 5/95 to 70/30.

As a coating method of the coating liquid for the undercoat layer, it is sufficient to appropriately select the most suitable method in consideration of physical properties and productivity of the coating liquid, and examples of the coating method include a spray method, a bar coating method, a roll coating method, a blade method, a ring method, and a dip coating method.

Among these, the dip coating method is a method of forming a layer on a surface of a conductive support by dipping the conductive support in a coating tank filled with a coating liquid and then pulling up the conductive support at a constant speed or a speed that changes successively, and is relatively simple and excellent in productivity and cost, and therefore can be suitably used for production of a photoreceptor. An apparatus used in the dip coating method may be provided with a coating liquid dispersing apparatus typified by an ultrasonic generator in order to stabilize dispersibility of the coating liquid.

A solvent in a coating film may be removed by natural drying, but the solvent in the coating film may be forcibly removed by heating.

A temperature in such a drying step is not particularly limited as long as the solvent used can be removed, but is suitably about 50 to 140° C., particularly preferably about 80 to 130° C.

When the drying temperature is less than 50° C., a drying time may be prolonged, and the solvent is not sufficiently evaporated and remains in the photoreceptor layer in some cases. Further, when the drying temperature exceeds about 140° C., electric characteristics of the photoreceptor during repeated use may be deteriorated, and the obtained image may be deteriorated.

Such temperature conditions are common not only in formation of the undercoat layer but also in formation of a layer such as the laminated photosensitive layer described below and other treatments.

A film thickness of the undercoat layer is not particularly limited, but is preferably 0.01 to 20 μm, and more preferably 0.05 to 10 μm.

When the film thickness of the undercoat layer is less than 0.01 μm, there is a risk that the undercoat layer does not substantially function as an undercoat layer, which makes it impossible to obtain a uniform surface nature by covering defects of the conductive support, and to prevent injection of charge from the conductive support to the laminated photosensitive layer. On the other hand, when the film thickness of the undercoat layer exceeds 20 μm, it is difficult to form a uniform undercoat layer, and there is a risk that the sensitivity of the photoreceptor is deteriorated.

Note that when the constituent material of the conductive support is aluminum, a layer containing alumite (alumite layer) can be formed to use as an undercoat layer.

In the photoreceptor of the disclosure, an impedance change rate of the undercoat layer when a frequency is changed from 4 Hz to 50 Hz is preferably −20% to −10%. When the impedance change rate is less than −20%, the effect of improving the piezoelectric streaks is not sufficiently obtained in some cases. On the other hand, when the impedance change rate exceeds −10%, the charging stability of the photoreceptor may be deteriorated.

The impedance change rate of the undercoat layer is more preferably −18% to −12%, still more preferably −16% to −14%.

The impedance change rate of the undercoat layer can be adjusted by material selection or the like, and can be adjusted by changing the blending of the inorganic compound fine particles and the blending amount thereof, for example, as described in Examples.

### Charge Generating Layer F22

The charge generating layer has a function of generating charge by absorbing light irradiated from a semiconductor laser or the like in an image forming apparatus or the like, and contains a charge generating material as a main component and contains a binder resin and an additive as necessary.

As the charge generating material, a compound used in the art can be used, and specific examples thereof include azo-based pigments such as monoazo-based pigments, bisazo-based pigments, and trisazo-based pigments; indigo-based pigments such as indigo and thioindigo; perylene-based pigments such as perylene imide and perylene acid anhydride; polycyclic quinone-based pigments such as anthraquinone and pyrenequinone; phthalocyanine-based pigments such as metal phthalocyanine and metal-free phthalocyanine such as titanyl phthalocyanine; organic photoconductive materials such as squarylium dyes, pyrylium salts, thiopyrylium salts, and triphenylmethane-based dyes; and inorganic photoconductive materials such as selenium and amorphous silicon, and a material having sensitivity in an exposure wavelength range can be appropriately selected and used. These charge generating materials may be used alone or in combination of two or more, and among these charge generating materials, phthalocyanine pigments are preferable in terms of charge generation efficiency.

Examples of a method for forming the charge generating layer include a method of vacuum depositing a charge generating material on a conductive support, and a method of applying a coating liquid for a charge generating layer obtained by dispersing a charge generating material in a solvent onto a conductive support. Among these, a method is preferable in which a charge generating material is dispersed in a binder resin solution obtained by mixing a binder resin in a solvent by a known method in the related art, and the obtained coating liquid for a charge generating layer is applied onto a conductive support or an undercoat layer. Next, this method will be described.

The binder resin is not particularly limited, and resin having binding properties used in the art and the binder resin exemplified in the description of the undercoat layer can be used, and resin having excellent compatibility with a charge generating material is preferable.

Examples of the binder resin include resins such as polyester, polystyrene, polyurethane, a phenol resin, an alkyd resin, a melamine resin, an epoxy resin, a silicone resin, an acrylic resin, a methacrylic resin, polycarbonate, polyarylate, polyphenoxy, polyvinyl butyral, and polyvinyl formal, and copolymer resins containing two or more of repeating units constituting these types of resin. Examples of the copolymer resin include insulating resins such as a vinyl chloride-vinyl acetate copolymer resin, a vinyl chloride-vinyl acetate-maleic anhydride copolymer resin, and an acrylonitrile-styrene copolymer resin. These types of resin can be used alone, or in combination of two or more.

Examples of the solvent include halogenated hydrocarbons such as dichloromethane and dichloroethane; ketones such as acetone, methyl ethyl ketone and cyclohexanone; esters such as ethyl acetate and butyl acetate; ethers such as tetrahydrofuran (THF) and dioxane; alkyl ethers of ethylene glycol such as 1, 2-dimethoxyethane; aromatic hydrocarbons such as benzene, toluene and xylene; and aprotic polar solvents such as N, N-dimethylformamide and N, N-dimethylacetamide, and these can be used alone or in combination of two or more. Among these solvents, non-halogen-based organic solvents are preferably used in consideration of the global environment.

A ratio (E/F) of a mass E of the charge generating material to a mass F of the binder resin is preferably, for example, about 55/45 to 80/20.

When the ratio (E/F) is less than 55/45, that is, when the mass E of the charge generating material is decreased, the charge generation efficiency may be lowered, and sensitivity may be deteriorated. On the other hand, when the ratio (E/F) exceeds 80/20, that is, the mass E of the charge generating material is increased, not only film strength of the charge generating layer decreases, but also dispersibility of the charge generating material decreases, coarse particles increase, and a surface charge of a portion other than a portion to be erased by exposure decreases, so that image defects, particularly, image fogging called black spots in which toner adheres to a white background to form fine black spots, may occur frequently.

The ratio is more preferably about 60/40 to 70/30.

Before the charge generating material is dispersed in the binder resin solution, the charge generating material may be subjected to pulverization treatment by a pulverizer in advance. Examples of the pulverizer used in the pulverization treatment include a paint shaker, a ball mill, a sand mill, an attritor, a vibration mill, and an ultrasonic disperser.

Examples of a dispersing machine used for dispersing the charge generating material in the binder resin solution include a paint shaker, a ball mill, and a sand mill. As dispersion conditions at this time, it is sufficient to appropriately select conditions so as to prevent impurities from being mixed due to abrasion of a container used and members constituting the dispersing machine, or the like. Examples of a method for applying the coating liquid for a charge generating layer include similar methods to the methods for applying the coating liquid for an undercoat layer, and a dip coating method is particularly preferable.

A film thickness of the charge generating layer is not particularly limited, but is preferably 0.05 to 5 μm, more preferably 0.1 to 1 μm.

When the film thickness of the charge generating layer is less than 0.05 μm, efficiency of light absorption is lowered, and the sensitivity of the photoreceptor may be lowered. On the other hand, when the film thickness of the charge generating layer exceeds 5 μm, charge movement in the charge generating layer becomes a rate-determining step in a process of erasing charge on a surface of the photosensitive layer, and the sensitivity of the photoreceptor may be deteriorated.

### Charge Transporting Layer F23

The charge transporting layer of the photoreceptor of the disclosure has a function of receiving charge generated by a charge generating material and transporting the charge to the surface of the photoreceptor, and contains a hole transporting material, a binder resin, an electron transporting material having a maximum absorption at a wavelength of equal to or less than 500 nm, and silica particles, and additives as necessary.

As the hole transporting material, a compound used in the art can be used, and specific examples thereof include carbazole derivatives, pyrene derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives, butadiene derivatives, enamine derivatives, benzidine derivatives, polymers having a group derived from these compounds in a main chain or a side chain (poly-N-vinylcarbazole, poly-1-vinylpyrene, ethylcarbazole-formaldehyde resin, triphenylmethane polymer, poly-9-vinylanthracene, and the like), polysilane, and the like. These hole transporting materials can be used alone, or in combination of two or more.

In the photoreceptor of the disclosure, a mass ratio of the hole transporting material to the electron transporting material is preferably 1.0 to 8.5.

When the mass ratio of the hole transporting material is less than 1.0, charge transporting efficiency may be lowered, and the sensitivity may be deteriorated. On the other hand, when the mass ratio of the hole transporting material exceeds 8.5, the effect of improving the piezoelectric streaks is not sufficiently obtained in some cases.

The mass ratio of the hole transporting material is preferably 3.0 to 8.0, and more preferably 4.0 to 6.0.

The charge transporting layer is formed, for example, as in the case of forming the charge generating layer F22 described above, by dissolving or dispersing the hole transporting material, the charge transporting material, the silica particles, and the binder resins, and as appropriate, the following additives in an appropriate solvent to prepare a coating liquid for a charge transporting layer, and applying the coating liquid onto the charge generating layer F22 by a spray method, a bar coating method, a roll coating method, a blade method, a ring method, a dip coating method, or the like. Among these coating methods, the dip coating method is particularly excellent in various points as described above, and therefore, is used in many cases, also in the case of forming the charge transporting layer.

The binder resin is not particularly limited, and a resin having binding properties used in the art can be used, and a resin having excellent compatibility with the hole transporting material is preferable.

Specific examples thereof include vinyl polymer resins such as polymethyl methacrylate, polystyrene, and polyvinyl chloride, copolymer resins thereof, types of resin such as polycarbonate, polyester, polyester carbonate, polysulfone, a phenoxy resin, an epoxy resin, a silicone resin, polyarylate, polyamide, polyether, polyurethane, polyacrylamide, a phenol resin, and polyphenylene oxide, and thermosetting resins obtained by partially crosslinking these types of resin. These binder resins can be used alone, or in combination of two or more.

Among these, polystyrene, polycarbonate, polyarylate, and polyphenylene oxide have a volume resistance value of equal to or greater than 10¹³Ω and are excellent in electrical insulation properties, and also excellent in film formability, potential characteristics, and the like, thus are preferable, and polycarbonate and polyarylate are more preferable, and polycarbonate is particularly preferable.

The charge transporting layer may contain additives such as a plasticizer, a leveling agent, and an antioxidant as necessary in order to improve film formability, flexibility, and surface smoothness.

Examples of the plasticizer include dibasic acid esters such as phthalic acid esters, fatty acid esters, phosphoric acid esters, chlorinated paraffins, and epoxy-type plasticizers.

Examples of the leveling agent include a silicone-based leveling agent.

Examples of the antioxidant include tribenzylamine.

Examples of the solvent include aromatic hydrocarbons such as benzene, toluene, and xylene; halogenated hydrocarbons such as dichloromethane, dichloroethane, and monochlorobenzene; ethers such as tetrahydrofuran, dioxane, and dimethoxymethyl ether; and aprotic polar solvents such as N, N-dimethylformamide. In addition, as necessary, a solvent such as alcohols, acetonitrile or methyl ethyl ketone may be further added for use. These solvents can be used alone, or in combination of two or more. Among these solvents, for example, a non-halogen-based organic solvent can be suitably used in consideration of the global environment.

A ratio (G/H) of a mass G of the hole transporting material to a mass H of the binder resin is preferably, for example, about 10/30 to 10/12.

When the ratio (G/H) is less than 10/30, that is, when the mass G of the hole transporting material is decreased, the charge transporting efficiency may be decreased, and the sensitivity may be deteriorated. On the other hand, when the ratio (G/H) exceeds 10/12, that is, when the mass G of the hole transporting material is increased, strength of the film may be lowered and the printing durability may be deteriorated.

The ratio is more preferably about 10/25 to 10/16.

A film thickness of the charge transporting layer is not particularly limited, but is preferably 18 to 42 μm, and more preferably 25 to 38 μm.

When the film thickness of the charge transporting layer is less than 18 μm, an effect of extending the life is not sufficiently obtained in some cases. On the other hand, when the film thickness of the charge transporting layer exceeds 42 μm, the electrical characteristics may be deteriorated.

### Surface Protecting Layer (not Illustrated in FIG. 1)

The photoreceptor of the disclosure may include a surface protecting layer on the laminated photosensitive layer. In the case of this photoreceptor, the surface protecting layer serving as the outermost surface layer contains an electron transporting material having a maximum absorption at a wavelength of equal to or less than 500 nm in a spectral absorption spectrum and silica particles, a mass ratio of the silica particles to the electron transporting material is 1.0 to 5.0, and an impedance change rate of the electrophotographic photoreceptor when a frequency is changed from 4 Hz to 50 Hz is −96% to −91%.

The constituent materials of the surface protecting layer, the contents and the content ratios thereof, the forming method, and the like are in accordance with those described in “Charge Transporting Layer”.

A film thickness of the surface protecting layer is not particularly limited, but is preferably 3 to 40 μm, more preferably 15 to 25 μm.

When the film thickness of the surface protecting layer is less than 3 μm, the effect of extending the life is not sufficiently obtained in some cases. On the other hand, when the film thickness of the surface protecting layer exceeds 40 μm, the charge transporting efficiency may be lowered, and the sensitivity may be deteriorated.

### (2) Process Cartridge

The process cartridge of the disclosure includes the photoreceptor of the disclosure, and at least one selected from a charging device that is a contact roller charger that charges the electrophotographic photoreceptor, a developing device that develops an electrostatic latent image formed by exposure to form a toner image, and a cleaning device that removes toner remaining on the electrophotographic photoreceptor.

For example, the process cartridge of the disclosure is configured by integrating the photoreceptor of the disclosure, the charging device, the developing device, and the cleaning device with a support member, but the process cartridge of the disclosure is not limited thereto. Since such a process cartridge is incorporated into an image forming apparatus, the image forming apparatus is provided with each part that is a constituent element of the process cartridge, and since the process cartridge is attachable and detachable to and from the image forming apparatus, replacement at the time of consumption becomes easy.

Each device of the process cartridge will be described in detail in (3) Image Forming Apparatus described below.

### (3) Image Forming Apparatus

An image forming apparatus of the disclosure includes at least the photoreceptor of the disclosure, a charging device that is a contact roller charger that charges the electrophotographic photoreceptor, an exposing device that exposes the charged electrophotographic photoreceptor to form an electrostatic latent image, a developing device that develops the electrostatic latent image to form a toner image, and a transferring device that transfers the toner image onto a recording medium.

The image forming apparatus of the disclosure may include a device selected from a fixing device that fixes a transferred toner image on a recording medium to form an image, a cleaning device that removes and collects toner remaining on the photoreceptor, and a charge neutralizing device that neutralizes a surface charge remaining on the photoreceptor.

Hereinafter, the image forming apparatus of the disclosure and operation thereof will be described using the drawings, but the image forming apparatus of the disclosure is not limited thereto.

FIG. 2 is a schematic side view illustrating a configuration of a main part of the image forming apparatus 50 of the disclosure.

The image forming apparatus 50 includes at least a photoreceptor 2 (corresponding to F01 in FIG. 1), a charging device 7 that charges a surface of the photoreceptor, an exposing device 11 that irradiates the charged surface of the photoreceptor with light to form an electrostatic latent image, a developing device 12 that develops the electrostatic latent image formed by the exposure to form a toner image, a transferring device 13 that transfers the toner image formed by the development onto a recording medium 26, a fixing device 19 that fixes the transferred toner image to the recording medium to form an image, and a cleaning device 14 that removes and collects toner remaining on the surface of photoreceptor. The charging device 7, the exposing device 11, the developing device 12, the transferring device 13, and the cleaning device 14 are provided in this order along an outer circumferential surface of the photoreceptor 2 from upstream to downstream in a rotation direction of the photoreceptor 2. Each of these constituent elements constituting the image forming apparatus 50 is accommodated in a housing 23.

The image forming apparatus 50 is an image forming apparatus according to an electrophotographic method in which an image is formed by using an electrophotographic technique. The image forming apparatus 50 may be a monochrome image forming apparatus capable of forming a monochrome image as illustrated in FIG. 2, or may be a color image forming apparatus according to an intermediate transfer method capable of forming a color image. Specifically, the image forming apparatus is, for example, a full-color image forming apparatus according to a so-called tandem method having a configuration in which a plurality of photoreceptors on each of which a toner image is formed are arranged in a predetermined direction (for example, in a horizontal direction or in a vertical direction). In addition, the image forming apparatus 50 may be another color image forming apparatus, a copying machine, a multifunction peripheral, or a facsimile machine.

### (3-1) Photoreceptor 2

The photoreceptor 2 is a member on the surface of which an electrostatic latent image and a toner image are formed, and images are continuously formed by rotation of the photoreceptor 2. The photoreceptor 2 is, for example, a photoreceptor drum.

The photoreceptor 2 is rotatably supported on a main body (not illustrated) of the image forming apparatus 50 and is driven to rotate in an arrow direction with a driving device (not illustrated). The driving device includes, for example, an electric motor and a reduction gear, and drives the photoreceptor 2 to rotate at a predetermined circumferential velocity by conveying a driving force to a conductive support 3 constituting a core body of the photoreceptor 2.

### (3-2) Charging Device 7

The charging device (charger) 7 is a device that uniformly charges the surface (outer circumferential surface) of the photoreceptor 2 to a predetermined potential. As the charger 7, for example, a contact charger having a roller shape, a belt shape, a blade shape, or the like can be used. Among these, the contact roller charger is preferable in the process cartridge and the image forming apparatus of the disclosure.

Note that it is optimal to apply only a direct-current (DC) voltage to a charging member such as a charging roller from the viewpoint of costs of a power source (high voltage application device) 18a, lives of the photoreceptor 2 and the charging member, and the like. That is, the charger preferably outputs a DC voltage.

The contact roller charger 7 may include, with a conductive support 28 as a substrate, an elastic layer 29 and a resistance layer 30 as coating layers in this order on an outer circumferential surface of the conductive support 28.

A method of forming the charging device will be described in detail in Examples.

### (3-2-1) Conductive Support 28

The conductive support 28 is not particularly limited as long as the conductive support 28 is electrically conductive and can maintain strength as a charging device material. Examples of a constituent material thereof include metals such as iron, copper, aluminum, and nickel, and alloys such as stainless steel and brass, and a surface thereof may be subjected to a plating treatment for rust prevention or provision of scratch resistance as long as the conductivity is not impaired.

In the embodiment, a cylindrical (round bar) member is used, but the shape thereof may be a hollow shape or a belt shape.

### (3-2-2) Elastic Layer 29

The elastic layer (conductive elastic layer) 29 is not particularly limited as long as the elastic layer 29 has appropriate conductivity and elasticity in order to ensure power supply to the photoreceptor as a body to be charged and good uniform adhesion of a charging apparatus to the photoreceptor.

In order to ensure the uniform adhesion between the charging roller and the photoreceptor, the elastic layer 29 is preferably polished to be formed in a shape (so-called crown shape) in which a central portion is the thickest and the thickness decreases as viewed from the central portion toward both end portions.

In general, the contact roller charger is brought into contact with the photoreceptor by applying a predetermined pressing force to both end portions of the conductive support. Therefore, the pressing force is small at a central portion and is large at both the end portions. Therefore, there is no problem when straightness of the contact roller charger is sufficient, but there is a problem that density unevenness occurs in images corresponding to the central portion and both the end portions when the straightness is not sufficient. Further, since a charging region is enlarged due to an increase in the number of models supporting only A3 and an increase in the number of color machines, thus a contact roller charger itself is easily bent by pressing forces only to both end portions of a conductive support, and a problem occurs that a gap is formed in a central portion. For this reason, in order to ensure the uniform adhesion between the charging apparatus and the photoreceptor, the elastic layer is preferably polished to be formed in a shape (so-called crown shape) in which the central portion is the thickest and the thickness decreases as viewed from the central portion toward both the end portions.

The elastic layer can be formed by a known method by appropriately adding a conductive agent having an electron conduction mechanism such as carbon black, graphite, or a conductive metal oxide, and a conductive agent having an ion conduction mechanism such as an alkali metal salt or a quaternary ammonium salt to an elastic material such as rubber. A volume resistivity of the elastic layer is preferably adjusted to exhibit a conductivity of less than 1×10¹⁰ Ωcm.

As a conductive material, zinc oxide particles are preferable.

Examples of the elastic material include natural rubber, synthetic rubber such as ethylene-propylene rubber (EPDM), styrene-butadiene rubber (SBR), silicone rubber, urethane rubber, epichlorohydrin rubber, isoprene rubber (IR), butadiene rubber (BR), nitrile-butadiene rubber (NBR), and chloroprene rubber (CR), and further, polyamide resins, polyurethane resins, and silicone resins, and a mixture of these may be used.

In addition, in order to provide required characteristics, the conductive elastic layer may contain additives such as a curing agent, a softening agent, an antioxidant, a crosslinking agent, a dispersing agent, and a plasticizer.

A film thickness of the elastic layer is not particularly limited, but is preferably 1 to 3 mm, more preferably 1.5 to 2 mm.

### (3-2-3) Resistance Layer 30

The resistance layer is formed in contact with the elastic layer, and is provided to prevent bleed-out of a softening oil, a plasticizer, or the like contained in the elastic layer to a surface of the charger and to adjust an electric resistance of the entire charger.

Examples of the material forming the resistance layer (hereinafter, also referred to as a “rubber base material”) include epichlorohydrin rubber, nitrile butadiene rubber (NBR), polyolefin-based thermoplastic elastomers, urethane-based thermoplastic elastomers, polystyrene-based thermoplastic elastomers, fluororubber-based thermoplastic elastomers, polyester-based thermoplastic elastomers, polyamide-based thermoplastic elastomers, polybutadiene-based thermoplastic elastomers, ethylene vinyl acetate-based thermoplastic elastomers, polyvinyl chloride-based thermoplastic elastomers, chlorinated polyethylene-based thermoplastic elastomers, and the like, and these material can be used alone, or in combination of two or more as a mixture or a copolymer.

The resistance layer has electrical conductivity or semiconductivity. Therefore, the resistance layer is formed by appropriately adding a conductive agent having an electron conduction mechanism (for example, conductive carbon, graphite, conductive metal oxide, copper, aluminum, nickel, iron powder, or the like) or a conductive agent having an ion conduction mechanism (for example, an alkali metal salt, an ammonium salt, or the like) to the above material.

In this case, two or more of various conductive agents may be used in combination in order to obtain a desired electric resistance. However, in consideration of environmental variation and contamination of the photoreceptor, a conductive agent having an electron conduction mechanism is preferably used.

The resistance layer may contain a filler as long as the effects of the image forming apparatus of the disclosure are not significantly impaired. The filler is not particularly limited, and examples thereof include calcium carbonate, talc, mica, silica, alumina, aluminum hydroxide, magnesium hydroxide, barium sulfate, zinc oxide, zeolite, wollastonite, diatomaceous earth, glass beads, bentonite, montmorillonite, asbestos, hollow glass spheres, graphite, molybdenum disulfide, titanium oxide, aluminum fibers, stainless steel fibers, brass fibers, aluminum powder, wood flour, rice husks, graphite, metal powder, conductive metal oxides, organometallic compounds, and organometallic salts, and these fillers can be used alone, or two or more can be used in combination.

A film thickness of the resistance layer is, for example, not particularly limited, but is preferably 5 to 100 μm, and more preferably 5 to 20 μm.

Elastic Body (not illustrated in FIG. 2)

The charging device is provided with a support member that supports the charging device at both end portions and an elastic body that expands and contracts in a direction from the support member toward the photoreceptor, and a linear pressure against the photoreceptor can be changed by a spring pressure of the elastic body. A pressure between the charging roller and the photoreceptor is suppressed to such a degree that image defects due to slipping do not occur, and image defects are less likely to occur.

In a contact charging roller of the process cartridge and the image forming apparatus of the disclosure, a charging roller linear pressure against the photoreceptor is preferably 30 to 55 gf/cm.

When the linear pressure is less than 30 gf/cm, charging roller slipping occurs under low temperature and low humidity environments, and image defects due to charging defects may occur. On the other hand, when the linear pressure exceeds 55 gf/cm, the effect of improving the piezoelectric streaks is not sufficiently obtained in some cases.

The charging roller linear pressure against the photoreceptor is more preferably 35 to 45 gf/cm, and still more preferably 35 to 40 gf/cm.

A method for measuring the linear pressure will be described in detail in Examples.

In addition, in the contact charging roller in the process cartridge and the image forming apparatus of the disclosure, an impedance change rate of a charging roller of a contact charger when a frequency is changed from 4 Hz to 50 Hz is preferably −70 to −60%.

When the impedance change rate exceeds −60%, the effect of improving the piezoelectric streaks is not sufficiently obtained in some cases. On the other hand, when the impedance change rate is less than −70%, the charging stability of the photoreceptor may be deteriorated.

The impedance change rate of the contact charging roller is more preferably −68% to −62%, and still more preferably −66% to −63%.

### (3-3) Exposing Device 11

The exposing device 11 is a device that emits light modulated based on image information. The exposing device 11 can be provided with a semiconductor laser or a light-emitting diode as a light source, and exposes the surface of the charged photoreceptor 2 according to image information by irradiating the surface (outer circumferential surface) of the photoreceptor 2 between the charger 7 and the developing equipment 12 with a laser beam emitted from the light source. The beam is repeatedly scanned in a main scanning direction, the direction in which a rotation axis of the photoreceptor 2 extends, and the beams are imaged to sequentially form electrostatic latent images on the surface of the photoreceptor 2. That is, the irradiation and non-irradiation of the laser beam cause a difference in a charge amount on the photoreceptor 2 uniformly charged by the charger 7, and this forms an electrostatic latent image.

### (3-4) Developing Device 12

The developing device (developing equipment) 12 is a device that develops an electrostatic latent image with a developer (toner) 25, the electrostatic latent image formed on the surface of the photoreceptor 2 by exposure, is provided to face the photoreceptor 2, and includes a developing roller 31 that supplies toner to the surface of the photoreceptor 2, and a casing 32 that rotatably supports the developing roller 31 around a rotation axis parallel to or substantially parallel to the rotation axis of the photoreceptor 2 and that stores a developer containing toner in an internal space of the casing.

### (3-5) Transferring Device 13

The transferring device (transfer charger) 13 is a device that transfers a toner image onto a transfer paper, the toner image being a visible image formed on the surface of the photoreceptor 2 by development, and the transfer paper being a recording medium 26 supplied to a gap between the photoreceptor 2 and the transfer charger 13 from a predetermined transport direction (arrow direction) by a conveyance device (not illustrated). The transferring device applies a predetermined high voltage to a transfer nip portion formed between the photoreceptor 2 and the transfer charger 13 by a power supplier (high voltage application device) 18b. The transferring device 13 can be configured similarly to the above charging device 7 and is, for example, a contact-type transferring device that transfers the toner image onto the recording medium 26 by applying, to the recording medium 26, a charge with a polarity opposite to that of the toner 25.

### (3-6) Fixing Device 19

The fixing device (fixing equipment) 19 is a device that fixes the toner image transferred to the recording medium 26 by the transferring device 13 to the recording medium 26. The fixing device 19 is provided on a downstream side relative to the transfer nip portion between the photoreceptor 2 and the transferring device 13 in the transport direction of the recording medium 26, and for example, the fixing device 19 includes a heating roller, and a pressure roller provided to face the heating roller, and the pressure roller is pressed against the heating roller to form a fixing nip portion.

### (3-7) Cleaning Device 14

The cleaning device (cleaner) 14 is a cleaning device that removes and collects the toner 25 remaining on the surface of the photoreceptor 2 after the transfer operation by the transferring device 13. The cleaner 14 includes a cleaning blade 34 that peels off the toner 25 remaining on the surface of the photoreceptor 2, and a collection casing 35 that stores the toner 25 peeled off by the cleaning blade 34.

(3-8) Charge Neutralizing Device (not illustrated in FIG. 2)

The image forming apparatus 50 preferably further includes a charge neutralizing device that neutralizes a surface charge remaining on the photoreceptor 2, and the charge neutralizing device is preferably provided together with the cleaning device 14.

As the charge neutralizing device, a device known in the art can be used.

Further, the image forming apparatus of the disclosure preferably further includes a separating device (separating claw) 20 that separates the recording medium 26 from the photoreceptor 2.

### (3-9) Controlling Device 15

The controlling device 15 is a part that controls the image forming apparatus 50, and includes, for example, a microcontroller including a CPU, a memory, a timer, an input/output port, and the like. The memory of the controlling device 15 stores control software for controlling the image forming apparatus 50.

Further, the image forming apparatus 50 may include a temperature and humidity sensor provided so as to be able to detect a use environment of the image forming apparatus 50.

### (3-10) Operation of Image Forming Apparatus

Operation of the image forming apparatus of the disclosure will be described using the image forming apparatus 50 described above.

First, when the photoreceptor 2 is driven to rotate in a predetermined rotation direction (arrow direction) by a driver, the surface of the photoreceptor 2 is supplied with negative charge from the charger 7 provided on an upstream side in the rotation direction of the photoreceptor 2 relative to an image formation point of light by the exposing device 11, and the surface of the photoreceptor 2 is uniformly charged to a predetermined positive potential.

For example, as illustrated in FIG. 2, while negative charge accumulates on the surface of the photoreceptor 2 and the surface of the photoreceptor 2 is charged, positive charge is generated on a surface of the conductive support 3 facing the charged surface of the photoreceptor 2 by a Coulomb force of the negative charge on the surface of the photoreceptor 2. As a result, the negative charge on the surface of the photoreceptor 2 is stabilized, and the surface of the photoreceptor 2 is uniformly charged. Therefore, in order to suppress occurrence of charging unevenness, it is important to quickly generate a positive charge on the surface of the conductive support 3 by the Coulomb force of the negative charge on the surface of the photoreceptor 2.

Next, the uniformly charged surface of the photoreceptor (Fa in FIG. 1) is irradiated with light according to image information from the exposing device 11. This exposure removes a surface charge of a light-irradiated portion in the photoreceptor 2. This causes a difference between a surface potential of the light-irradiated portion and a surface potential of a non-light-irradiated portion and forms an electrostatic latent image.

The toner 25 is supplied from the developing device 12 provided on a downstream side in the rotation direction of the photoreceptor 2 relative to the image formation point of light by the exposing device 11 to the surface of the photoreceptor 2, on which the electrostatic latent image is formed, and the electrostatic latent image is developed and a toner image is formed.

In synchronization with the exposure of the photoreceptor 2, the recording medium 26 is supplied to the transfer nip portion between the photoreceptor 2 and the transferring device 13 in the transport direction (arrow direction) of the transfer paper. The transferring device 13 applies the charge with a polarity opposite to that of the toner 25 to the supplied recording medium 26, and the toner image formed on the surface of the photoreceptor 2 is transferred onto the recording medium 26.

The recording medium 26 onto which the toner image is transferred is conveyed to the fixing device 19 by a conveyor, and the toner image is heated and pressed when passing through a contact portion between the heating roller and the pressure roller of the fixing device 19, or the fixing nip portion, and is fixed on the recording medium 26 to form a solid image. The recording medium 26 on which the image is thus formed is ejected to an outside of the image forming apparatus 50 by the conveyance device.

On the other hand, the toner 25 remaining on the surface of the photoreceptor 2 even after the transfer of the toner image by the transferring device 13 is peeled off from the surface of the photoreceptor 2 by the cleaning blade 34 of the cleaning device 14 and collected in the collection casing 35.

The charge on the surface of the photoreceptor 2 from which the toner 25 is thus removed is removed, and the electrostatic latent image on the surface thereof disappears. Thereafter, the photoreceptor 2 is further driven to rotate, and the series of operations starting from the charging is repeated again to continuously form images.

When the image forming apparatus 50 includes the charge neutralizing device on a downstream side of the cleaning device 14 and before the charging device 7, the charge on the surface of the photoreceptor 2 is efficiently and more reliably eliminated by light from a charge eliminating lamp of the charge neutralizing device, and the electrostatic latent image on the surface of the photoreceptor 2 disappears.

### EXAMPLES

The disclosure will be specifically described below by Examples and Comparative Examples, but the disclosure is not limited to the following Examples as long as the gist of the disclosure is not exceeded.

In each of Examples and Comparative Examples, a laminated photoreceptor having only a laminated photosensitive layer on a surface side of the photoreceptor was adopted, but similar results are obtained even when the laminated photoreceptor further having a surface protecting layer on the laminated photosensitive layer is used.

Note that physical properties of materials used and obtained photoreceptors in Examples and Comparative Examples were measured by the following methods.

Maximum Absorption Wavelength of Electron Transporting Material Spectral absorption spectra of electron transporting materials, or the compounds 1 to 3, were measured in a wavelength range from 380 to 700 nm using an ultraviolet-visible spectrophotometer (UV-VIS SPECTROPHOTOMETER, model: UV-2450, manufactured by Shimadzu Corporation), and a maximum absorption wavelength is determined as λmax from the obtained spectral absorption spectra.

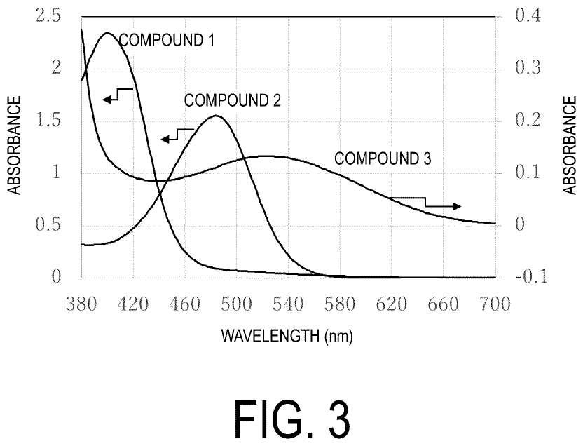

FIG. 3 is a graph showing the spectral absorption spectra of the electron transporting materials (the compounds 1 and 2) used in Examples and the electron transporting material (the compound 3) used in Comparative Example. It can be seen from this graph that the maximum absorption wavelengths of the compounds 1 to 3 are 400 nm, 480 nm, and 528 nm, respectively.

### BET Specific Surface Area of Silica Particles

A BET specific surface area (m²/cm) of silica particles pretreated by vacuum degassing at a temperature of 200° C. for 60 minutes was measured under conditions of an adsorption gas of N₂ and a measuring temperature of 77 K using a specific surface area meter (manufactured by Anton Paar, specific surface area/pore size analyzer, model: Nova800).

### Impedance Change Rate of Photoreceptor, Undercoat Layer, and Charging Roller

Impedance of each of the photoreceptors, undercoat layers, and charging rollers were measured using an impedance analyzer (manufactured by Hioki E. E. Corporation, model: IM3570) under an environment of 25° C./50% while applying DC 1.0 V and changing a frequency from 4 Hz to 50 Hz, and an impedance change rate Z_{RC}(%) was calculated from an impedance Z₄ at the frequency 4 Hz and an impedance Z₅₀ at the frequency 50 Hz according to the following formula.

The impedance change rate Z_{RC}(%)=[(Z₅₀−Z₄)/Z₄]×100

The impedance of each photoreceptor was measured after the photoreceptor was produced.

The impedance of the undercoat layer was measured before formation of a charge generating layer in each of Examples 1, 9, and 10, and a result of Example 1 was transferred to Examples 2 to 8 and Comparative Examples 1 to 3 under the same conditions.

The impedance of the charging roller was measured after production of the charging roller in each of Examples 1, 13, and 14, and a result of Example 1 was transferred to Examples 2 to 12 and Comparative Examples 1 to 3 under the same conditions.

### Linear Pressure of Charging Roller

A film-type pressure sensor (manufactured by Nitta Corporation, inter-roller pressure profile measuring system, model: PINCH A4) was inserted between the photoreceptor and the charging roller, and a linear pressure (gf/cm) of the charging roller against the photoreceptor was calculated from a displayed contact area and a total load value.

### Example 1

### Production of Photoreceptor

### Formation of Undercoat Layer

3 parts by mass of titanium oxide (manufactured by Showa Denko K.K., product name: TS-043) and 2 parts by mass of copolyamide (nylon) (manufactured by Toray Industries, Inc., product name: Amilan (trade name) grade: CM8000) were added to 25 parts by mass of methanol, and the mixture was subjected to a dispersion treatment for 8 hours with a paint shaker (dispersing machine) to prepare 3 kg of a coating liquid for an undercoat layer.

A coating tank was filled with the obtained coating liquid for an undercoat layer, a drum-shaped substrate made of aluminum having a diameter of 30 mm and a length of 255 mm as the conductive support F1 was immersed in the coating liquid and then pulled up, and the obtained coating film was naturally dried to form the undercoat layer F21 having a film thickness of 1.5 μm on the conductive support F1.

### Formation of Charge Generating Layer

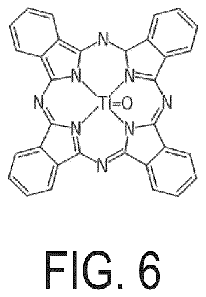

Next, as a charge generating material, 1 part by mass of Y-type oxotitanyl phthalocyanine (manufactured by Nippon Zairyo Co., Ltd., product name: TPL-530) represented by a structural formula in FIGS. 6:
and 1 part by mass of polyvinyl butyral (PVB) resin (manufactured by Sekisui Chemical Co., Ltd., product name: S-LEC BX-1) as a binder resin were added, to 98 parts by mass of methylethylketone, and the mixture was dispersed for 2 hours with a paint shaker using glass beads (manufactured by AS ONE Corporation, product name: BZ-1, bead size: 1 mm) as media to prepare 3 kg of a coating liquid for a charge generating layer.

The obtained coating liquid for a charge generating layer was applied onto the undercoat layer F21 by a similar dipping method to that in the case of forming the undercoat layer, and the obtained coating film was naturally dried to form the charge generating layer F22 having a film thickness of 0.2 μm.

### Formation of Charge Transporting Layer

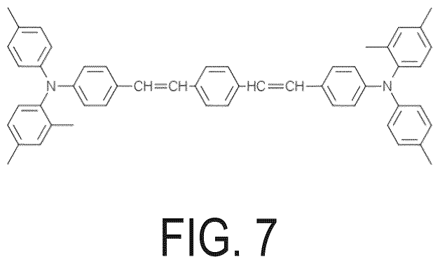

Next, to a glass container having a volume of 900 mL, 20 parts by mass of silica (fumed silica, primary particle size 16 nm, BET specific surface area=130 m³/g, dimethyldichlorosilane surface treatment, manufactured by Nippon Aerosil Co., Ltd., product name: AEROSIL (trade name) R972) as silica particles, 5.6 parts by mass of an electron transporting compound (the compound 1, λmax=400 nm) represented by the structural formula in FIG. 4 as an electron transporting material, 30 parts by mass of a stilbene derivative (compound 4) represented by a structural formula in FIG. 7 as a hole transporting material, and 60 parts by mass of polycarbonate (manufactured by Teijin Chemicals Ltd., product name: TS2050) as a binder resin were added, and 400 parts by mass of tetrahydrofuran were added, stirred and mixed, and stirred for 30 hours in a ball-mill.

Note that the above compounds 1 and 4 were used after being prepared in advance based on the method described in JP 6661994 B, and the method described in JP 3272257 B, respectively.

The obtained mixture was subjected to a 5-pass dispersion treatment using a particle-dispersing device (manufactured by Microfluidics Corporation, model: Microfluidizer M-110P), and the obtained dispersion liquid was left to stand for 3 days under a condition of a temperature of 20° C., thereby preparing 3 kg of a coating liquid for a charge transporting layer.

The obtained coating liquid for a charge transporting layer was applied onto the charge generating layer F22 by a similar dipping method to that in the case of forming the undercoat layer, and the obtained coating film was dried at a temperature of 130° C. for 1.5 hours to form the charge transporting layer F23 having a film thickness of 30 μm, thereby producing the photoreceptor F01 illustrated in FIG. 1.

### Production of Contact Roller Charger (Charging Roller)

### Formation of Elastic Layer

50 g of an electrically conductive rubber composition was obtained by kneading 100 parts by mass of acrylonitrile-butadiene rubber (NBR, manufactured by Zeon Corporation, product name: Nipol (trade name) DN219) as a rubber ingredient (elastic material), 10 parts by mass of carbon black (manufactured by Lion Corporation, product name: Ketjenblack EC600JD) as an electrically conductive material, 5.00 parts by mass of ricinoleic acid (manufactured by Tokyo Chemical Industry Co., Ltd., Ricinoleic Acid) as a softening agent, 1.2 parts by mass of sulfur (manufactured by Tsurumi Chemical Industry Co., Ltd., product name: sulfur-SULFAX (trade name) PTC) as a vulcanizing agent, and 3 parts by mass of tetrabenzylthiuram disulfide (TBzTD, manufactured by Sanshin Chemical Industry Co., Ltd., product name: Sanceler TBzTD) as a vulcanizing accelerator.

The obtained rubber composition was poured into a mold in which the conductive support 28 made of SUM23 (free-cutting steel) having a diameter of 9 mm and a length of 250 mm was set in advance, and was heated and vulcanized at an internal temperature of 160° C. for 30 minutes using an electric oven, thereby forming the elastic layer 29 having a film thickness of 2 mm.

### Formation of Resistance Layer

500 g of a rubber composition of a surface layer material was obtained by diluting 100 parts by mass of N-methoxymethylated nylon 1 (manufactured by Namariichi Co., Ltd., product name: FR101) as a bonding resin, 20 parts by mass of carbon black (manufactured by Lion Corporation, product name: Ketjenblack EC600JD) as a conductive material, and 30 parts by mass of irregular nylon particles (mean particle size: 20 μm, manufactured by Arkema Inc., Orgasol series) as unevenness-forming particles with 200 parts by mass of methanol, adding soda-lime glass (manufactured by AS ONE Corporation, product name: soda-glass beads) thereto, and stirring the mixture for 60 minutes with a ball-mill.

The obtained rubber was melt-extruded using an annular die to produce a seamless tube to be the resistance layer 30. Air was blown from one end of the obtained seamless tube to inflate the tube, and the conductive support (roller) formed with the elastic layer 29 was inserted into the tube to form the resistance layer 30, thereby producing the charging roller 7 having a diameter of 12 mm.

Thereafter, a linear pressure against the photoreceptor was calculated by setting a spring pressure of an elastic body expanding and contracting in a direction from a support member that supports the obtained charging roller at both end portions thereof toward the photoreceptor to 550 g/F, and the contact roller charger (charging roller) 7 having a linear pressure of 35 gf/cm was produced.

### Example 2

A photoreceptor of Example 2 was produced similarly to Example 1 except that 5.6 parts by mass of the compound 1 being the electron transporting material was changed to 9.5 parts by mass in the formation of the charge transporting layer of the photoreceptor.

Additionally, a charging roller of Example 2 was produced similarly to Example 1.

### Example 3

A photoreceptor of Example 3 was produced similarly to Example 1 except that 5.6 parts by mass of the compound 1 being the electron transporting material was changed to 5.0 parts by mass in the formation of the charge transporting layer of the photoreceptor.

Additionally, a charging roller of Example 3 was produced similarly to Example 1.

### Example 4

A photoreceptor of Example 4 was produced similarly to Example 1 except that 5.6 parts by mass of the compound 1 being the electron transporting material was changed to 20 parts by mass in the formation of the charge transporting layer of the photoreceptor.

Additionally, a charging roller of Example 4 was produced similarly to Example 1.

### Example 5

A photoreceptor of Example 5 was produced similarly to Example 1 except that 5.6 parts by mass of the compound 1 being the electron transporting material was changed to 4 parts by mass in the formation of the charge transporting layer of the photoreceptor.

Additionally, a charging roller of Example 5 was produced similarly to Example 1.

### Example 6

A photoreceptor of Example 6 was produced similarly to Example 1 except that in the formation of the charge transporting layer of the photoreceptor, instead of the compound 1 being the electron transporting material, an electron transporting compound represented by the structural formula in FIG. 5 (the compound 2, λmax=480 nm) was used.

Note that as the above compound 2, a compound was used that was prepared in advance based on the method described in JP 6023735 B.

Additionally, a charging roller of Example 6 was produced similarly to Example 1.

### Example 7

A photoreceptor of Example 7 was produced similarly to Example 1 except that 30 parts by mass of the compound 4 being the hole transporting material was changed to 5 parts by mass in the formation of the charge transporting layer of the photoreceptor.

Additionally, a charging roller of Example 7 was produced similarly to Example 1.

### Example 8

A photoreceptor of Example 8 was produced similarly to Example 1 except that 30 parts by mass of the compound 4 being the hole transporting material was changed to 50 parts by mass in the formation of the charge transporting layer of the photoreceptor.

Additionally, a charging roller of Example 8 was produced similarly to Example 1.

### Example 9

A photoreceptor of Example 9 was produced similarly to Example 1, except that silica (fumed silica, primary particle size 17 nm, BET specific surface area=110 m³/g, surface treated with dimethyldichlorosilane, manufactured by CABOT, product name: CAB-O-SIL (trade name) TS-610) was used as the silica particles in the formation of the charge transporting layer of the photoreceptor.

Additionally, a charging roller of Example 9 was produced similarly to Example 1.

### Example 10

A photoreceptor of Example 10 was produced similarly to Example 1, except that silica (fumed silica, primary particle size 12 nm, BET specific surface area=170 m³/g, surface treated with dimethyldichlorosilane, manufactured by Nippon Aerosil Co., Ltd, product name: AEROSIL (trade name) R974) was used as the silica particles in the formation of the charge transporting layer of the photoreceptor. Additionally, a charging roller of Example 10 was produced similarly to Example 1.

### Example 11

A photoreceptor of Example 11 was produced similarly to Example 1, except that silica (fumed silica, primary particle size 40 nm, BET specific surface area=50 m³/g, surface treated with hexamethyldisilazane, manufactured by Nippon Aerosil Co., Ltd., product name: AEROSIL (trade name) RX50) was used as the silica particles in the formation of the charge transporting layer of the photoreceptor. Additionally, a charging roller of Example 11 was produced similarly to Example 1.

### Example 12

A photoreceptor of Example 12 was produced similarly to Example 1, except that silica (fumed silica, primary particle size 7 nm, BET specific surface area=280 m³/g, surface treated with dimethyldichlorosilane, manufactured by Nippon Aerosil Co., Ltd, product name: AEROSIL (trade name) R976) was used as the silica particles in the formation of the charge transporting layer of the photoreceptor. Additionally, a charging roller of Example 12 was produced similarly to Example 1.

### Example 13

A photoreceptor of Example 13 was produced similarly to Example 1 except that 3 parts by mass of titanium oxide in the formation of the undercoat layer of the photoreceptor was changed to 15 parts by mass.

Additionally, a charging roller of Example 13 was produced similarly to Example 1.

### Example 14

A photoreceptor of Example 14 was produced similarly to Example 1 except that 3 parts by mass of titanium oxide in the formation of the undercoat layer of the photoreceptor was changed to 1 part by mass.

Additionally, a charging roller of Example 14 was produced similarly to Example 1.

### Example 15

A photoreceptor of Example 15 was produced similarly to Example 1.

A charging roller of Example 15 was produced similarly to Example 1 except that the spring pressure 550 g/F of the elastic body was changed to 250 g/F (linear pressure 25 gf/cm) in the production of the charging roller.

### Example 16

A photoreceptor of Example 16 was produced similarly to Example 1.

Additionally, a charging roller of Example 16 was produced similarly to Example 1 except that the spring pressure 550 g/F of the elastic body was changed to 1050 g/F (linear pressure 60 gf/cm) in the production of the charging roller.

### Example 17

A photoreceptor of Example 17 was produced similarly to Example 1.

Additionally, a charging roller of Example 17 was produced similarly to Example 1 except that 20 parts by mass of carbon black was changed to 10 parts by mass in the formation of the resistance layer of the charging roller.

### Example 18

A photoreceptor of Example 18 was produced similarly to Example 1.

Additionally, a charging roller of Example 18 was produced similarly to Example 1 except that 20 parts by mass of carbon black was changed to 30 parts by mass in the formation of the resistance layer of the charging roller.

### Comparative Example 1

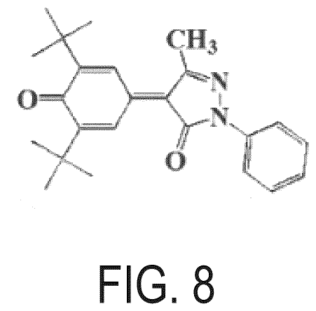

A photoreceptor of Comparative Example 1 was produced similarly to Example 1 except that in the formation of the charge transporting layer of the photoreceptor, instead of the compound 1 being the electron transporting material, a compound represented by a structural formula in FIG. 8 (the compound 3, λmax=528 nm) was used.

Note that as the above compound 3, a compound was used that was prepared in advance based on the method described in JP 4041741 B.

Additionally, a charging roller of Comparative Example 1 was produced similarly to Example 1.

### Comparative Example 2

A photoreceptor of Comparative Example 2 was produced similarly to Example 1 except that 5.6 parts by mass of the compound 1 being the electron transporting material was changed to 30 parts by mass in the formation of the charge transporting layer of the photoreceptor.

Additionally, a charging roller of Comparative Example 2 was produced similarly to Example 1.

### Comparative Example 3

A photoreceptor of Comparative Example 3 was produced similarly to Example 1 except that 5.6 parts by mass of the compound 1 being the electron transporting material was changed to 3.5 parts by mass in the formation of the charge transporting layer of the photoreceptor.

Additionally, a charging roller of Comparative Example 3 was produced similarly to Example 1.

### Evaluations

The photoreceptors and the charging rollers produced in Examples 1 to 14 and Comparative Examples 1 to 3 were evaluated according to the following items. In the following evaluations (1) to (3), each of the photoreceptors and the charging rollers was mounted on a unit of a digital multifunction peripheral (manufactured by Sharp Corporation, model: BP C50) modified for testing, for evaluation.

### (1) Piezoelectric Streaks

A photoreceptor to be evaluated was left to stand for 10 days under conditions of a temperature of 30° C. and a humidity of 85%, and a halftone image was output on one sheet of A4 paper, and a level of occurrence of streaks was visually checked. Piezoelectric streaks were determined from a piezoelectric streak level of the check result according to the following criteria.

### Determination Criteria

VG: No streak-like image defect is seen.

Usable without any problem even in a multifunction peripheral or a printer that requires a long life and high image quality

G: Streak-like image defects are faintly seen.

Usable without any problem in any device other than a multifunction peripheral or a printer that requires a long life and high image quality

NB: Streak-like image defects are seen.

Usable for any inexpensive multifunction peripheral or printer

B: Streak-like image defects are clearly seen.

Problematic in actual use (difficult to use)

### (2) Charging Roller Slipping

Presence or absence of image defects due to charging roller slipping was visually checked when a character test chart (ISO19752) was printed on 100000 sheets of recording paper using a digital copier for testing equipped with a process unit (a photoreceptor and a charging roller) to be evaluated under conditions of a temperature of 5° C./20%. From results of the check, charging roller slipping was determined according to the following criteria.

### Determination Criteria

VG: No uneven image defect is seen.

Usable without any problem even in a multifunction peripheral or a printer that requires a long life and high image quality

G: Faint uneven image defects are seen in a very small part of an end portion.

Usable without any problem in any device other than a multifunction peripheral or a printer that requires a long life and high image quality

NB: Uneven image defects are faintly seen.

Usable for any inexpensive multifunction peripheral or printer

B: Uneven image defects are clearly seen.

Problematic in actual use (difficult to use)

### (3) Durability and Charging Stability of Photoreceptor

A photoreceptor and a charging roller to be evaluated were mounted on a digital copier for testing, developing equipment was removed from the digital copier, and a surface potentiometer (manufactured by Trek Japan Co., Ltd., model: MODEL 344) was attached to a portion a developing device instead. An initial charge potential was measured under an environment of a temperature of 25° C. and a relative humidity of 50%. Next, the developing equipment was returned, the character test chart (ISO19752) was printed on 100000 sheets of recording paper, and then a charge potential of the photoreceptor after printing was measured by a similar method. A difference AVO (V) in the measured charge potentials was used for evaluating charging stability serving as an index of sensitivity deterioration due to repeated use according to the following determination criteria.

In addition, in order to check durability of the photoreceptor, a film thickness of the photoreceptor was measured at the initial stage and after completion of the printing on 100000 sheets, a film reduction amount ΔT (μm) was calculated, and the durability was evaluated according to the following determination criteria.

### Determination Criteria for Durability

$$VG : Δ T < 3.$$

Usable without any problem even in a multifunction peripheral or a printer that requires a long life and high image quality

$$G : 3. \leq Δ T < 6.0$$

Usable without any problem in any device other than a multifunction peripheral or a printer that requires a long life and high image quality

$$NB : 6.0 \leq Δ T < 9.0$$

Usable for any inexpensive multifunction peripheral or printer

$$B : 9. \leq Δ T$$

Problematic in actual use (difficult to use)

### Determination Criteria for Charging Stability

$$VG : Δ V 0 < 40$$

Usable without any problem even in a multifunction peripheral or a printer that requires a long life and high image quality

$$G : 40 \leq Δ V 0 < 80$$

Usable without any problem in any device other than a multifunction peripheral or a printer that requires a long life and high image quality

$$NB : 80 \leq Δ V 0 < 120$$

Usable for any inexpensive multifunction peripheral or printer

$$B : 120 \leq Δ V 0$$

Problematic in actual use (difficult to use)

### (4) Comprehensive Evaluation

Based on the evaluation results of the above evaluations (1) to (3), a comprehensive evaluation was made according to the following criteria.

VG: There are three or more VG, but no NB or B.

Usable without any problem even in a multifunction peripheral or a printer that requires a long life and high image quality

G: There is no NB or B.

Usable without any problem in any device other than a multifunction peripheral or a printer that requires a long life and high image quality

NB: There is NB, but no B.

Usable for any inexpensive multifunction peripheral or printer

B: There is x.

Problematic in actual use (difficult to use)

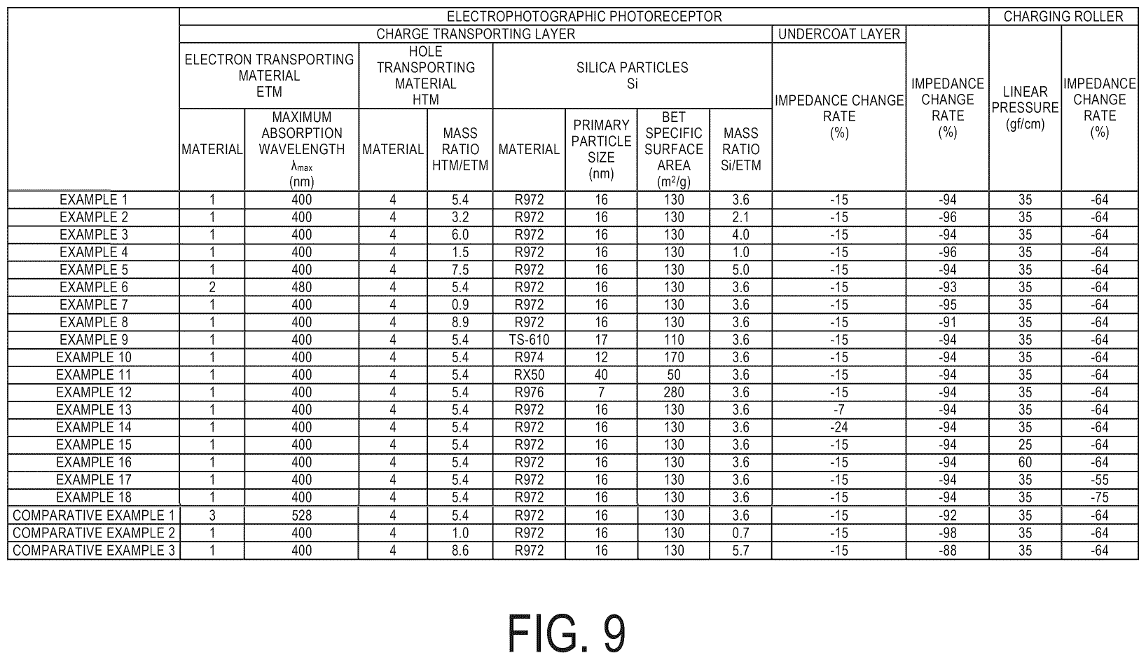

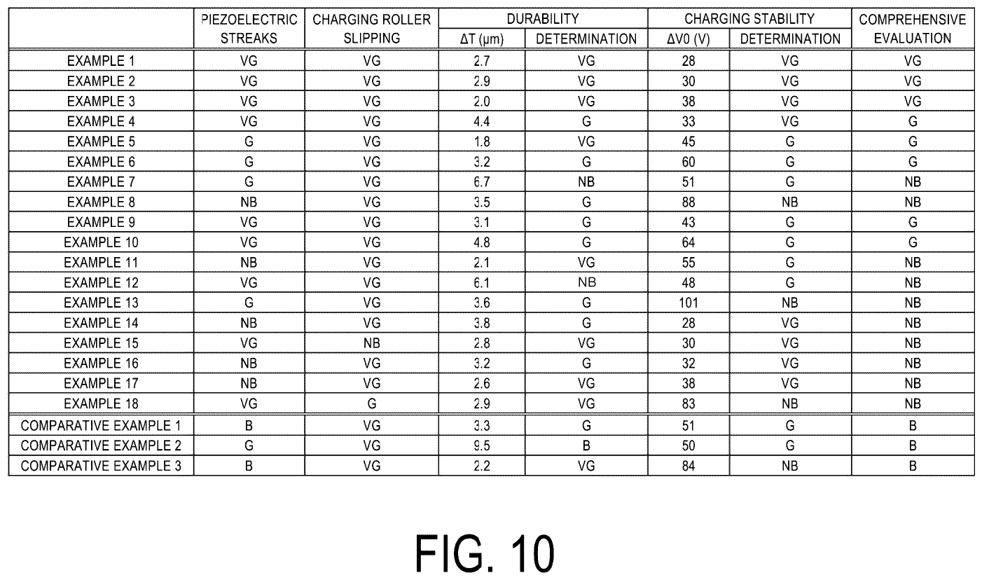

The main constituent materials of the photoreceptors and the physical properties thereof, the physical properties of the photoreceptors and each part thereof, and the physical properties of the charging rollers are shown in FIG. 9, and the evaluation results of the photoreceptors and the charging rollers are shown in FIG. 10.

FIG. 9 and FIG. 10 reveal the following.
(1) With the photoreceptors satisfying the constituent requirements of the disclosure (Examples 1 to 18), good image quality can be continuously obtained for a long period of time, whereas the photoreceptors not satisfying the constituent requirements of the disclosure (Comparative Examples 1 to 3) are inferior
(2) With the photoreceptor (Example 1) in which the electron transporting material is the compound 1, good image quality can be continuously obtained for a longer period of time as compared with the photoreceptor (Example 6) in which the electron transporting material is the compound 2
(3) With the photoreceptors (Examples 1 to 5) containing the hole transporting material at a mass ratio of 1.0 to 8.5 to the electron transporting material, good image quality can be continuously obtained for a longer period of time as compared with the photoreceptors (Examples 7 and 8) not satisfying the requirement of the mass ratio
(4) With the photoreceptors (Examples 1 and 9 to 10) in which the silica particles have the BET specific surface area of 100 to 200 m²/g, good image quality can be continuously obtained for a longer period of time as compared with the photoreceptors (Examples 11 and 12) not satisfying the requirement of the BET specific surface area
(5) With each of the photoreceptors (Examples 1 and 4 to 6) that includes the undercoat layer between the conductive support and the laminated photosensitive layer, and in which the undercoat layer has the impedance change rate of −20% to −10% when the frequency was changed from 4 Hz to 50 Hz, good image quality can be continuously obtained for a longer period of time as compared with the photoreceptors (Examples 13 and 14) not satisfying the requirement of the impedance change rate
(6) With the process cartridges and the image forming apparatuses (Examples 1 to 18) satisfying the constituent requirements of the disclosure, good image quality can be continuously obtained for a long period of time, whereas the process cartridges and the image forming apparatuses (Comparative Examples 1 to 3) not satisfying the constituent requirements of the disclosure are inferior
(7) With the process cartridges and the image forming apparatuses (Examples 1 and 4 to 6) in which the charging roller linear pressure of the contact roller charger against the photoreceptor is 30 to 55 gf/cm, good image quality can be continuously obtained for a longer period of time as compared with process cartridges and image forming apparatuses (Examples 15 and 16) not satisfying the requirement of the charging roller linear pressure
(8) With the process cartridges and the image forming apparatuses (Examples 1 and 4 to 6) in which the impedance change rate of the charging roller of the contact roller charger when the frequency was changed from 4 Hz to 50 Hz was −70 to −60%, good image quality can be continuously obtained for a longer period of time as compared with process cartridges and image forming apparatuses (Examples 17 and 18) not satisfying the requirement of the impedance change rate

### DESCRIPTION OF SYMBOLS

F01 Electrophotographic photoreceptor
F1 Conductive support
F21 Undercoat layer
F22 Charge generating layer
F23 Charge transporting layer
Fa Electrophotographic photoreceptor surface
50 Image forming apparatus
23 Housing
2 Electrophotographic photoreceptor
3 Conductive support
4 Photosensitive layer (laminated photosensitive layer)
Arrow Rotation direction of electrophotographic photoreceptor
7 Charging device (contact roller charger)
28 Conductive support
29 Elastic layer
30 Resistance layer
18a Power supplier (high voltage application device)
11 Exposing device
12 Developing device (developing equipment)
31 Developing roller
32 Casing
25 Developer (including toner)
13 Transferring device (transfer charger)
18b Power supplier (high voltage application device)
26 Recording medium (recording paper or transfer paper)
19 Fixing device (fixing equipment)
14 Cleaning device (cleaner)
34 Cleaning blade
35 Collection casing
15 Controlling device
20 Separating device (separating claw)

1. An electrophotographic photoreceptor at least comprising, on a conductive support:
a laminated photosensitive layer in which a charge generating layer that contains a charge generating material and a charge transporting layer that contains a hole transporting material are laminated in this order; or
the laminated photosensitive layer and a surface protecting layer laminated on the laminated photosensitive layer, wherein
the charge transporting layer or the surface protecting layer that serves as an outermost surface layer of the electrophotographic photoreceptor contains an electron transporting material that has a maximum absorption at a wavelength of equal to or less than 500 nm in a spectral absorption spectrum and a silica particle, and a mass ratio of the silica particle to the electron transporting material is 1.0 to 5.0, and
an impedance change rate of the electrophotographic photoreceptor in a case where a frequency is changed from 4 Hz to 50 Hz is −96% to −91%.

2. The electrophotographic photoreceptor according to claim 1, wherein
the electron transporting material is a compound 1 represented by a structural formula that follows.

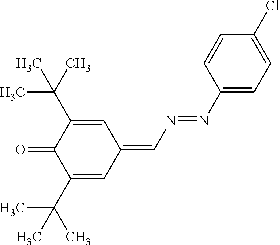 [SMILES: CC(C)(C)C1=CC(=C/N=N/c2ccc(Cl)cc2)C=C(C(C)(C)C)C1=O]

3. The electrophotographic photoreceptor according to claim 1, wherein
a mass ratio of the hole transporting material to the electron transporting material is 1.0 to 8.5.

4. The electrophotographic photoreceptor according to claim 1, wherein
the silica particle has a BET specific surface area of 100 to 200 m²/g.

5. The electrophotographic photoreceptor according to claim 1, comprising an undercoat layer between the conductive support and the laminated photosensitive layer, wherein
an impedance change rate of the undercoat layer is −20% to −10% in a case where a frequency is changed from 4 Hz to 50 Hz.

6. A process cartridge, comprising:
the electrophotographic photoreceptor according to claim 1; and
at least one selected from
a charging device that is a contact roller charger that charges the electrophotographic photoreceptor,
a developing device that develops an electrostatic latent image formed by exposure to form a toner image, and
a cleaning device that removes toner remaining on the electrophotographic photoreceptor.

7. The process cartridge according to claim 6, wherein
a charging roller linear pressure of the contact roller charger to the electrophotographic photoreceptor is 30 to 55 gf/cm.

8. The process cartridge according to claim 6, wherein
an impedance change rate of a charging roller of the contact roller charger in a case where a frequency is changed from 4 Hz to 50 Hz is −70 to −60%.

9. An image forming apparatus, at least comprising:
the electrophotographic photoreceptor according to claim 1;
a charging device that is a contact roller charger that charges the electrophotographic photoreceptor;
an exposing device that exposes the charged electrophotographic photoreceptor to form an electrostatic latent image;
a developing device that develops the electrostatic latent image to form a toner image; and
a transferring device that transfers the toner image onto a recording medium.

10. The image forming apparatus according to claim 9, wherein
a charging roller linear pressure of the contact roller charger to the electrophotographic photoreceptor is 30 to 55 gf/cm.

11. The image forming apparatus according to claim 9, wherein
an impedance change rate of a charging roller of the contact roller charger in a case where a frequency is changed from 4 Hz to 50 Hz is −60 to −70%.
